(19) United States
(12) Patent Application Publication
(10) Pub. No.: US 2006/0178936 A1
(43) Pub. Date: Aug. 10, 2006

(54) Electronic device for verifying a user's personal information

(76) Inventors: Doreen C. Boxer, Santa Cruz, CA (US); Cynthia Zapata, Santa Cruz, CA (US)

Correspondence Address: ASHKAN NAJAFI, P.A., 6817 SOUTHPOINT PARKWAY, SUITE 2301, JACKSONVILLE, FL, 32216, US

(21) Appl. No.: 11/043,251

(22) Filed: Jan. 27, 2005

(51) Int. Cl. G06Q 20/00

(52) U.S. Cl. 705/18

(57) ABSTRACT

An electronic identity verifying device includes a housing, a microprocessor, and a memory including software instructions coupled to the microprocessor. The device further includes a user interface including a display screen and an associated implement electrically coupled thereto. A communication link is operably connected to the microprocessor and a personal identification card reader is electrically coupled to the microprocessor. A power source is electrically mated to the housing and a mechanism is included for supporting the housing against a support surface. The device also includes a touch screen interface for allowing the user to interactively exchange data with the device. A plurality of light emitting sources are electrically coupled to the microprocessor and are selectively illuminable during a transaction process.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to a device for verifying personal information and, more particularly, to an electronic device removably attachable to an auxiliary register system for verifying a user's personal information during point-of-sale transactions.

2. Prior Art

The use of thumb print readers is known in the prior art. More specifically, thumb print readers heretofore devised and utilized for the purpose of scanning a thumbprint are known to consist basically of familiar, expected and obvious structural configurations, notwithstanding the myriad of designs encompassed by the crowded prior art which have been developed for the fulfillment of countless objectives and requirements. Cash register systems which enable the performance of transactions, such as cash issuance at terminals remote from and in communication with a host data processing system having a central database in which account and other information is stored, are well known.

Such systems, which are frequently used by grocery stores and other commercial settings to extend their services, and permit the completion of a transaction through a cash register. Such a cash register typically includes a mechanism for receiving and reading information from a card, a user input such as a keyboard, a display and document entry and exit apertures.

Issuing a personal ID number with each credit/debit card attains increased security for the issuance of cash or other transactions without intervention of a second party. A credit/debit card transaction is then enabled only when an ID number corresponding to the account number read from the credit/debit card is entered through the keyboard. This required correspondence prevents a thief or mere finder of a credit/debit card from receiving cash, for example, from a terminal or a cash register.

Upon entry by a terminal user or a customer of a credit/debit card and personal identification number, the terminal is instructed to communicate the credit/debit card data and the personal identification number to the host for authorization of the transaction. At the host, a database of identification numbers is accessed by the card data. The identification number obtained from the database is compared with the personal identification number received from the terminal to perform a host PIN check.

When ID cards, credit cards or debit cards are stolen, passwords and/or ID numbers read from card can be decrypted. Thus, presenting a password or a personal identification number with a card is woefully inadequate in preventing individuals other than the registered users from accessing the computer. Obviously, it would be advantageous to use a means of identification that is absolutely unique to the credit/debit card holder, such as their fingerprint.

Accordingly, a need remains for an electronic device for verifying a user's personal information in order to overcome the above-noted shortcomings. The present invention satisfies such a need by providing an electronic identity verifying device that improves the identification method currently used to complete a transaction through means of proper fingerprint matching. Such a device is easy to use, increases a user's peace of mind, and greatly reduces the incidence of bank and credit/debit card fraud or abuse. This saves all parties involved a great amount of time, energy and most importantly, money.

### BRIEF SUMMARY OF THE INVENTION

In view of the foregoing background, it is therefore an object of the present invention to provide an electronic device for verifying a user's personal information. These and other objects, features, and advantages of the invention are provided by an electronic device removably attachable to an auxiliary register system for verifying the identity of the user during point-of-sale transactions.

The device includes a housing, a microprocessor positioned within the housing and a memory electrically coupled to the microprocessor. Such a memory includes software instructions that cause the device to perform the steps of instructing the user to place at least one metacarpal on a fingerprint reader and scanning a print of the metacarpal into a temporary storage medium. Subsequent steps performed include scanning a remotely located central database housing a plurality of pre-scanned fingerprint data and comparing the user's fingerprint with the database such that the identity of the user can advantageously be determined based on a matching fingerprint data found in the database.

The register system verifies the user's identity if the matching fingerprint data is located in the database, thereby conveniently allowing the user to complete the point-of-sale transaction without providing a picture ID.

A user interface is situated on the housing. Such a user interface includes a display screen and an associated implement electrically coupled thereto such that the user may effectively sign their name on the display screen in an electronic format.

A communication link is operably connected to the microprocessor for transmitting data signals to the register system during operating conditions. Such a communication link preferably includes a modem such that the device can effectively communicate with the register system and the remotely located fingerprint database through a telephony data transfer system. The communication link my also include a transceiver for wirelessly transmitting and receiving a control signal to the register system and the remotely located fingerprint database wherein the control signal provides a series of encrypted instructions embedded in a RF transmission signal.

A personal identification card reader is electrically coupled to the microprocessor wherein the user may swipe their identification card through the reader to initiate a verification process. A power source is electrically mated to the housing for effectively providing a selected power supply to the device during operating conditions.

The device further includes a mechanism for conveniently supporting the housing against a support surface such that the user may readily bias a position of the housing as needed during operating conditions. Such a supporting mechanism may include a plurality of hook and loop members connected to an outer surface of the housing such that the housing may be removably connected to a support surface and maintained at a substantially fixed position.

In an alternate embodiment, the supporting mechanism may include a mounting bracket removably securable to the support surface and an elongated pivot rod that has annular end portions rotatably connected to the housing and the mounting bracket such that the housing can be selectively articulated between alternating positions for advantageously assisting a user to visually identify the display screen during operating conditions. Of course, the mounting bracket may have a generally C-shaped cross-section and associated locking pin for mounting to a counter surface, for example. Alternately, the mounting bracket may have a generally rectangular shape with a planar bottom surface for being engaged on top of the support surface via a plurality of fastening members.

A touch screen interface is included, conveniently allowing the user to interactively exchange data with the device without requiring third party intervention from the register system. A plurality of light emitting sources are electrically coupled to the microprocessor and are selectively illuminable during a transaction process such that the user may be readily prompted during the verification process.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a front elevational view showing an electronic device for verifying a user's personal information, in accordance with the present invention;

FIG. 2 is a side elevational view of the device shown in FIG. 1, taken along line 2-2;

FIG. 3 is front elevational view showing an alternate embodiment of the device shown in FIG. 1;

FIG. 4 is a side elevational view of the device shown in FIG. 3, taken along line 4-4;

FIG. 5 is a front elevational view showing yet another embodiment of the device shown in FIG. 1;

FIG. 6 is a partial cross-sectional view of the supporting mechanism shown in FIG. 5, showing the elongated pivot rod and its associated annular end portions;

FIG. 7 is a schematic block diagram of the device shown in FIG. 5;

FIG. 8 is a side elevational view of the device shown in FIG. 5, showing the rectangular mounting bracket wherein the USB cable and the power cord extend from the bottom of the support bracket; and

FIG. 9 is a side elevational view of the device shown in FIG. 8, showing the USB cable and the power cord extending from the pivot rod.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this application will be thorough and complete, and will fully convey the true scope of the invention to those skilled in the art. Like numbers refer to like elements throughout the figures and prime and double prime numbers refer to alternate embodiments of such elements.

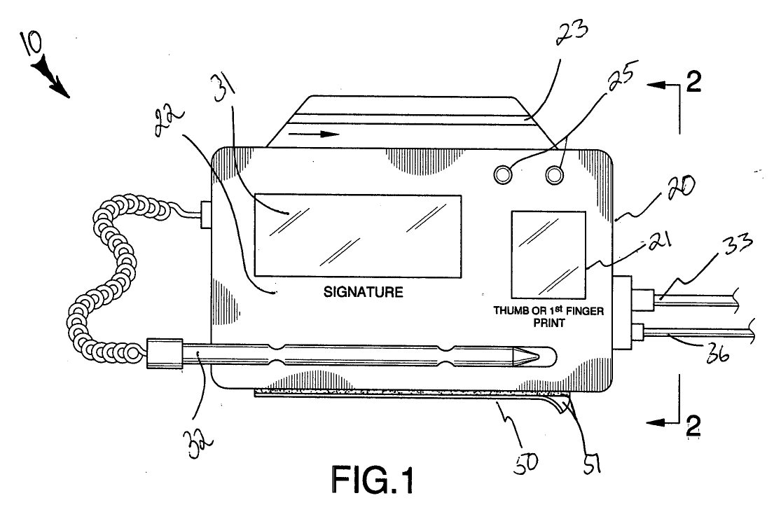

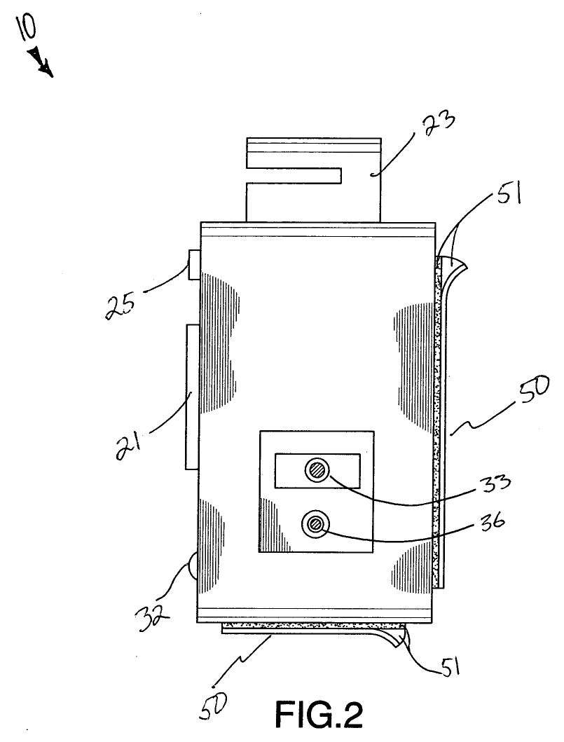

The device of this invention is referred to generally in FIGS. 1-9 by the reference numeral 10 and is intended to provide an electronic device for verifying a user's personal information. It should be understood that the device 10 may be used to verify personal information in many different types of settings and should be construed as limited in use to only verifying a user's personal information during point-of-sale transactions.

Referring initially to FIG. 1, the device 10 includes a housing 20, a microprocessor 30 positioned within the housing 20, and a memory 40 electrically coupled to the microprocessor 30. Such a memory 40 includes software instructions 41 that cause the device 10 to perform the steps of instructing the user to place at least one metacarpal on a fingerprint reader 21 and scanning a print of the metacarpal into a temporary storage medium. Subsequent steps performed include scanning a remotely located central database housing a plurality of pre-scanned fingerprint data and comparing the user's fingerprint with the database such that the identity of the user can advantageously be determined based on matching fingerprint data found in the database. The register system verifies the user's identity if matching fingerprint data is located in the database, thereby conveniently allowing the user to complete the point-of-sale transaction without providing a picture ID.

Referring to FIGS. 1, 5 and 7, a user interface 22 is situated on the housing 20. Such a user interface 22 includes a display screen 31 and an associated implement 32 electrically coupled thereto such that the user may effectively sign their name on the display screen 32 in an electronic format.

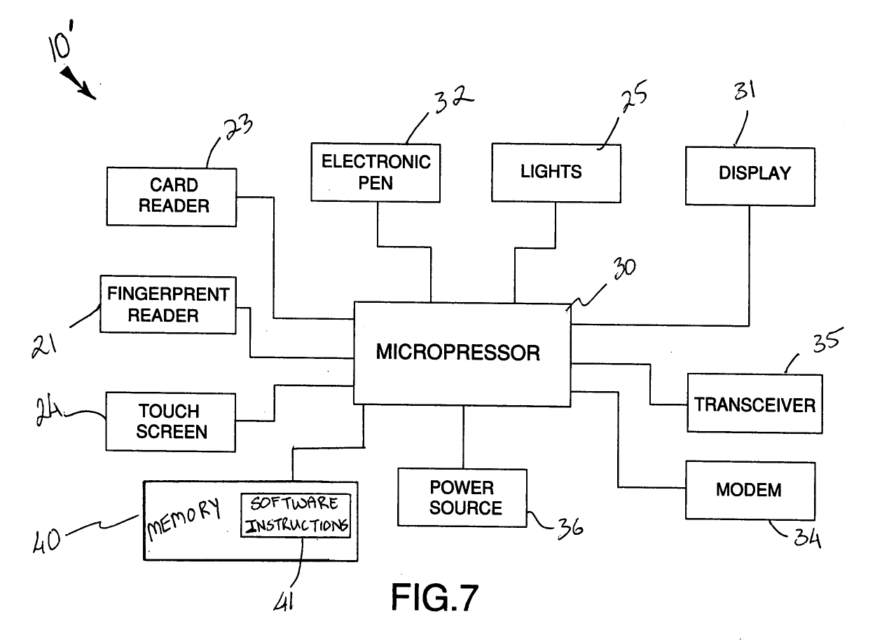

Referring to FIG. 7, a communication link 33 is operably connected to the microprocessor 30 for transmitting data signals to the register system during operating conditions. Such a communication link 33 includes a modem 34 such that the device 10 can effectively communicate with the register system and the remotely located fingerprint database through a telephony data transfer system. The communication link 33 also includes a transceiver 35 for wirelessly transmitting and receiving a control signal to the register system and the remotely located fingerprint database wherein the control signal provides a series of encrypted instructions embedded in a RF transmission signal.

Referring to FIGS. 1 through 5, 7, 8 and 9, a personal identification card reader 23 is electrically coupled to the microprocessor 30 wherein the user may swipe their identification card through the reader 23 to initiate a verification process. Of course, such a personal identification card reader 23 may be located along any surface of the housing 20, as is well known to an individual of ordinary skill in the art. Still referring to FIGS. 1 through 5, 7, 8 and 9, a power source 36 is electrically mated to the housing 20 for effectively providing a selected power supply to the device 10 during operating conditions.

Referring to FIGS. 1, 2 and 4, the device 10 further includes a mechanism 50 for conveniently supporting the housing 20 against a support surface such that the user may readily bias a position of the housing 20 as needed during operating conditions. In a preferred embodiment, such a supporting mechanism 50 includes a plurality of hook and loop members 51 connected to an outer surface of the housing 20 such that the housing 20 may be removably connected to a support surface and maintained at a substantially fixed position.

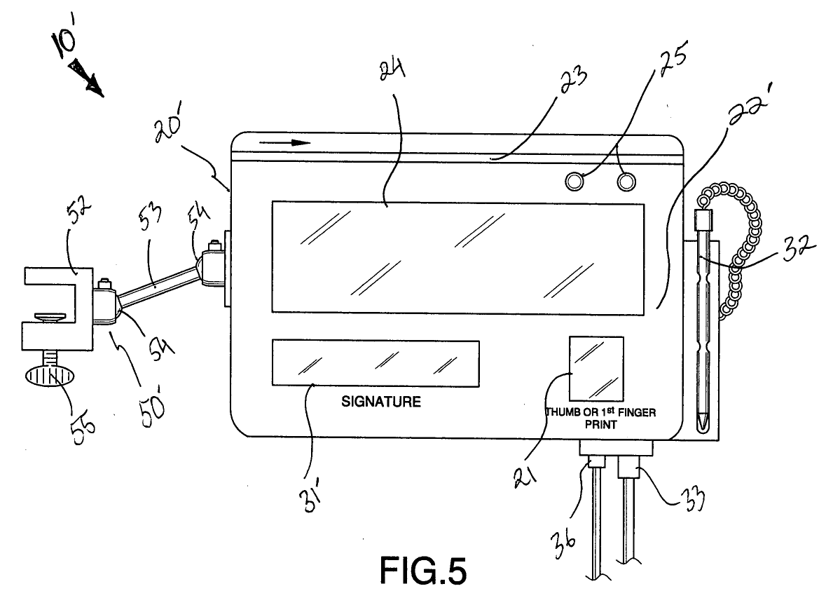

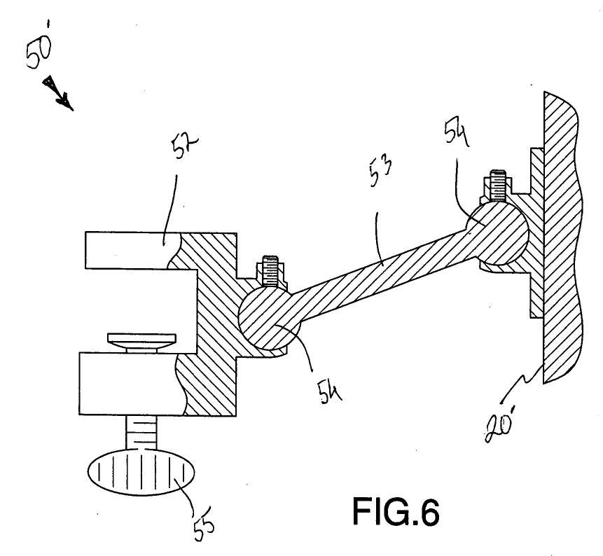

Referring to FIGS. 5 and 6, in an alternate embodiment 10′, the supporting mechanism 50′ includes a mounting bracket 52 removably securable to the support surface and an elongated pivot rod 53 that has annular end portions 54 rotatably connected to the housing 20 and the mounting bracket 52 such that the housing 20 can be selectively articulated between alternating positions for advantageously assisting a user to visually identify the display screen 31 during operating conditions.

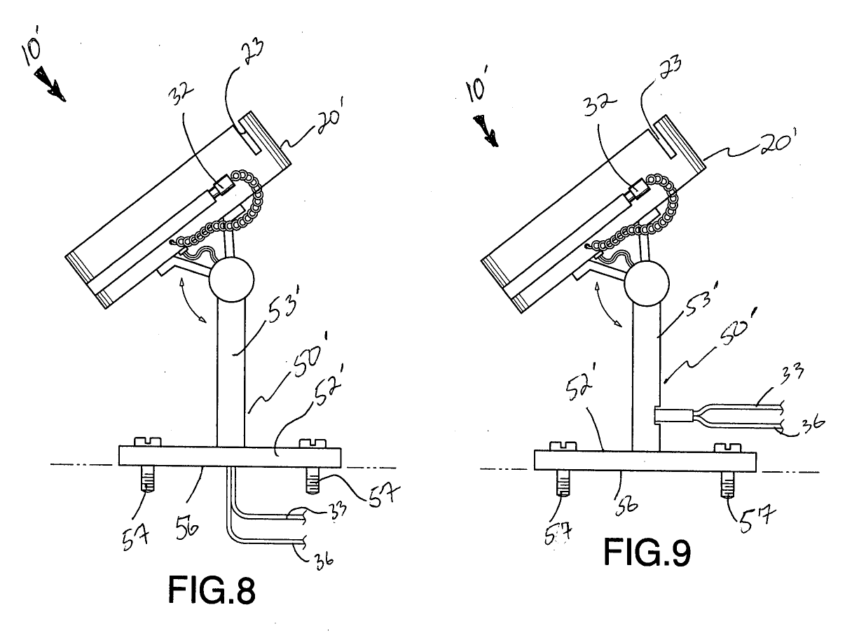

Of course, the mounting bracket 52 may have a generally C-shaped cross-section and associated locking pin 55 for mounting to a counter surface, for example. Alternately, the mounting bracket 52′ may have a generally rectangular shape with a planar bottom surface 56 for being engaged on top of the support surface via a plurality of fastening members 57, as best illustrated in FIGS. 8 and 9. Of course, in such an embodiment 52′, the power source 36 and the communication link 33 may pass through the bottom surface 56 of the mounting bracket 52′ or vertically out of the pivot rod 53′, as illustrated in FIGS. 8 and 9, respectively.

Referring to FIG. 5, in an alternate embodiment 10′, a touch screen interface 24 is included, conveniently allowing the user to interactively exchange data with the device 10 without requiring third party intervention from the register system. This feature further ensures that a user's private and secret information is not disclosed to unauthorized individuals.

Referring to FIGS. 1 through 5, and 7, a plurality of light emitting sources 25 are electrically coupled to the microprocessor 30 and are selectively illuminable during a transaction process such that the user may be readily prompted during the verification process. Such light emitting sources 25 may, of course, include alternately colored lights wherein, for example, one color indicates a successful transaction or authorized card bearer, whereas another color indicates an unsuccessful transaction or an unauthorized card bearer.

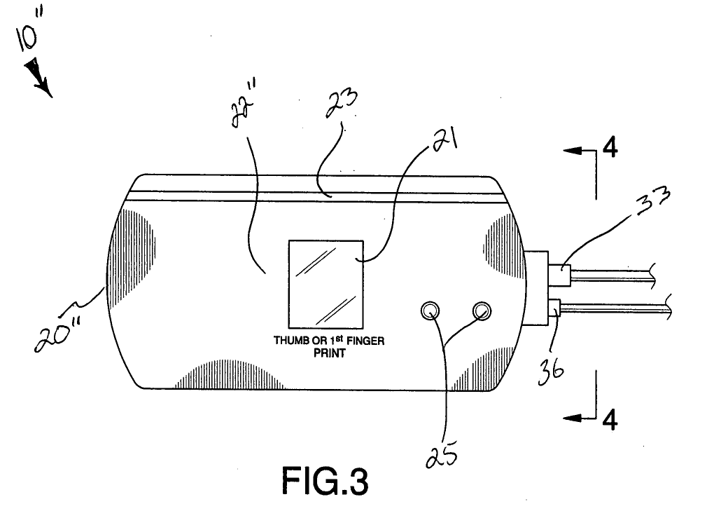

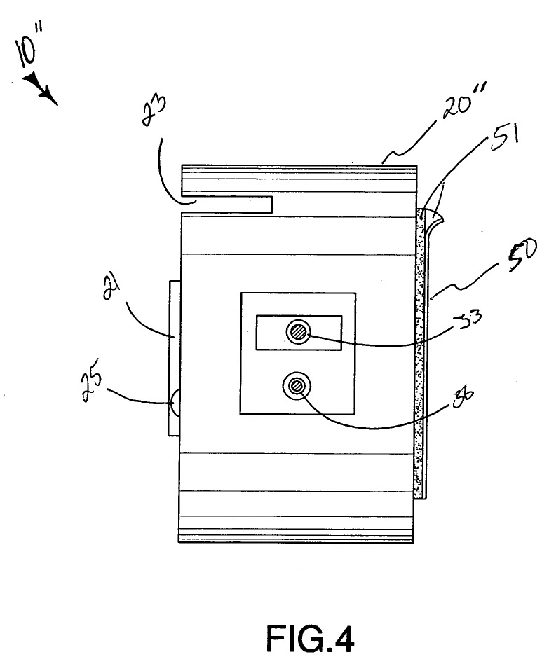

In yet another embodiment 10″, the device 10 only includes the fingerprint reader 21 and the card reader 23, as is best shown in FIGS. 3 and 4. Thus it should be understood that the device 10 may include any combination of the fingerprint reader 21, card reader, 23, touch screen 24, display screen 31 and electronic implement 32, as is illustrated in FIGS. 1, 3 and 5. Furthermore, by using fingerprint verification as a means for identification in all devices 10, 10′ and 10″, a user is advantageously ensured that no other unauthorized person can use their credit/debit card because each individual has a fingerprint that is unique to them.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. An electronic device removably attachable to an auxiliary register system for verifying the identity of the user during point-of-sale transactions, said device comprising:
a housing;
a microprocessor positioned within said housing;
a memory electrically coupled to said microprocessor and including software instructions that cause the device to perform the steps of:
instructing the user to place at least one metacarpal on a fingerprint reader,
scanning a print of the metacarpal into a temporary storage medium,
scanning a remotely located central database housing a plurality of pre-scanned fingerprint data and comparing the user's fingerprint with the database such that the identity of the user can be determined based on a matching fingerprint data found in the database,
wherein the register system verifies the user's identity if the matching fingerprint data is located in the database and thereby allowing the user to complete the point-of-sale transaction without providing a picture ID;
a user interface situated on said housing, said user interface including a display screen and an associated implement electrically coupled thereto such that the user may sign their name on the display screen in an electronic format;
a communication link operably connected to said microprocessor for transmitting data signals to the register system during operating conditions;
a personal identification card reader electrically coupled to said microprocessor wherein the user may swipe their identification card through said reader to initiate a verification process; and
a power source electrically mated to said housing for providing a selected power supply to said device during operating conditions.

2. The device of claim 1, wherein said communication link comprises:
a modem such that said device can communicate with the register system and the remotely located fingerprint database through a telephony data transfer system.

3. The device of claim 1, wherein said communication link comprises:
a transceiver for wirelessly transmitting and receiving a control signal to the register system and the remotely located fingerprint database wherein said control signal provides a series of encrypted instructions embedded in a RF transmission signal.

4. The device of claim 1, further comprising:
a touch screen interface for allowing the user to interactively exchange data with said device without requiring third party intervention from the register system.

5. The device of claim 1, further comprising:
a plurality of light emitting sources electrically coupled to said microprocessor and being selectively illuminable during a transaction process such that the user may be readily prompted during the verification process.

6. An electronic device removably attachable to an auxiliary register system for verifying the identity of the user during point-of-sale transactions, said device comprising:
a housing;
a microprocessor positioned within said housing;
a memory electrically coupled to said microprocessor and including software instructions that cause the device to perform the steps of:
instructing the user to place at least one metacarpal on a fingerprint reader,
scanning a print of the metacarpal into a temporary storage medium,
scanning a remotely located central database housing a plurality of pre-scanned fingerprint data and comparing the user's fingerprint with the database such that the identity of the user can be determined based on a matching fingerprint data found in the database,
wherein the register system verifies the user's identity if the matching fingerprint data is located in the database and thereby allowing the user to complete the point-of-sale transaction without providing a picture ID;
a user interface situated on said housing, said user interface including a display screen and an associated implement electrically coupled thereto such that the user may sign their name on the display screen in an electronic format;
a communication link operably connected to said microprocessor for transmitting data signals to the register system during operating conditions;
a personal identification card reader electrically coupled to said microprocessor wherein the user may swipe their identification card through said reader to initiate a verification process;
a power source electrically mated to said housing for providing a selected power supply to said device during operating conditions; and
means for supporting said housing against a support surface such the user may readily bias a position of said housing as needed during operating conditions.

7. The device of claim 6, wherein said communication link comprises:
a modem such that said device can communicate with the register system and the remotely located fingerprint database through a telephony data transfer system.

8. The device of claim 6, wherein said communication link comprises:
a transceiver for wirelessly transmitting and receiving a control signal to the register system and the remotely located fingerprint database wherein said control signal provides a series of encrypted instructions embedded in a RF transmission signal.

9. The device of claim 6, further comprising:
a touch screen interface for allowing the user to interactively exchange data with said device without requiring third party intervention from the register system.

10. The device of claim 6, further comprising:
a plurality of light emitting sources electrically coupled to said microprocessor and being selectively illuminable during a transaction process such that the user may be readily prompted during the verification process.

11. An electronic device removably attachable to an auxiliary register system for verifying the identity of the user during point-of-sale transactions, said device comprising:
a housing;
a microprocessor positioned within said housing;
a memory electrically coupled to said microprocessor and including software instructions that cause the device to perform the steps of:
instructing the user to place at least one metacarpal on a fingerprint reader,
scanning a print of the metacarpal into a temporary storage medium,
scanning a remotely located central database housing a plurality of pre-scanned fingerprint data and comparing the user's fingerprint with the database such that the identity of the user can be determined based on a matching fingerprint data found in the database,
wherein the register system verifies the user's identity if the matching fingerprint data is located in the database and thereby allowing the user to complete the point-of-sale transaction without providing a picture ID;
a user interface situated on said housing, said user interface including a display screen and an associated implement electrically coupled thereto such that the user may sign their name on the display screen in an electronic format,
a communication link operably connected to said microprocessor for transmitting data signals to the register system during operating conditions;
a personal identification card reader electrically coupled to said microprocessor wherein the user may swipe their identification card through said reader to initiate a verification process;
a power source electrically mated to said housing for providing a selected power supply to said device during operating conditions;
means for supporting said housing against a support surface such the user may readily bias a position of said housing as needed during operating conditions;
a touch screen interface for allowing the user to interactively exchange data with said device without requiring third party intervention from the register system; and
a plurality of light emitting sources electrically coupled to said microprocessor and being selectively illuminable during a transaction process such that the user may be readily prompted during the verification process.

12. The device of claim 11, wherein said communication link comprises:
a modem such that said device can communicate with the register system and the remotely located fingerprint database through a telephony data transfer system.

13. The device of claim 11, wherein said communication link comprises:
a transceiver for wirelessly transmitting and receiving a control signal to the register system and the remotely located fingerprint database wherein said control signal provides a series of encrypted instructions embedded in a RF transmission signal.

14. The device of claim 11, wherein said supporting means comprises:
a mounting bracket removably securable to the support surface; and
an elongated pivot rod having annular end portions rotatably connected to said housing and said mounting bracket such that said housing can be selectively articulated between alternating positions for assisting a user to visually identify said display screen during operating conditions.

15. The device of claim 11, wherein said supporting means comprises:
a plurality of hook and loop members connected to an outer surface of said housing such that said housing may be removably connected to a support surface and maintained at a substantially fixed position.
